(19) United States
(12) Patent Application Publication
(10) Pub. No.: US 2006/0215838 A1
(43) Pub. Date: Sep. 28, 2006

(54) Encryption method and apparatus in a conditional access system for digital broadcasting

(75) Inventors: Seok-Min Hwang, Seoul (KR); Sang-Il Choi, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/297,756

(22) Filed: Dec. 8, 2005

(30) Foreign Application Priority Data
Dec. 8, 2004 (KR) 103248/2004

(51) Int. Cl. H04L 9/00

(52) U.S. Cl. 380/268

(57) ABSTRACT

An encryption method and apparatus in a conditional access system which interworks with a smart card to receive digital broadcasting are provided. A smart card interface acquires a random value rather than a fixed unique value, encrypts a key value with the random value, for communication with the smart card, and sends the encrypted key value and the random value to the smart card. Upon receipt of a response signal including descrambling information corresponding to the encrypted key value from the smart card, the smart card interface sends the descrambling information to a descrambler so that the descrambler can descramble scrambled broadcasting data. The random value can be the position information of a path with the highest energy, decided in a signal searcher of a terminal.

### PRIORITY

This application claims priority under 35 U.S.C. §119 to an application entitled “Encryption Method And Apparatus In Conditional Access System For Digital Broadcasting” filed in the Korean Intellectual Property Office on Dec. 8, 2004, and assigned application number 103248/2004, the contents of which are incorporated herein by reference.

### BACKGROUND OF THE INVENTION

1. Field of the Invention

The present invention relates generally to a Conditional Access System (CAS) for digital broadcasting service, and in particular, to a method and apparatus for encrypting communications between a smart card interface and a smart card to enable only an authorized subscriber to view broadcasting in a CAS.

2. Description of the Related Art

Digital broadcasting, for example, Digital Multimedia Broadcasting (DMB) is a broadcasting service for allowing subscribers to view multichannel multimedia broadcasting via portable receivers or vehicular receivers irrespective of time and place. If the DMB is serviced through a satellite, it is called satellite DMB. This satellite DMB service sends broadcast programs to authorized subscribers only, compared to general TV broadcasting aimed to unspecified many viewers. Thus, a CAS is provided to block unauthorized subscribers from viewing programs.

The CAS is a core system for paid digital broadcasting, along with a subscriber management system. The CAS enables only authorized subscribers to receive the digital broadcasting service accurately and conveniently. From a broadcasting service provider's viewpoint, the CAS protects business profits by preventing illegal viewing, and is useful in providing viewer-oriented broadcasting service based on marketing materials including subscriber preferences.

To receive digital multimedia broadcasting, communications are conducted between a smart card and a smart card interface being software for implementing the CAS. These communications need to be encrypted to provide the digital broadcasting service to authorized subscribers only.

FIG. 1 illustrates interfacing between a smart card and a smart card interface in a typical digital broadcast receiving terminal.

Referring to FIG. 1, a CAS 10 built in a terminal includes a smart card interface 12 and a descrambler 16, for authenticating and filtering messages and data received from a digital broadcast transmitter at the terminal in conjunction with a smart card 14. The smart card interface 12 performs mutual authentication between the smart card 14 and the terminal. The descrambler 16 including a filter and descrambles scrambled broadcasting data received from the digital broadcast transmitter. The smart card 14 is comprised of a processor provided to a subscriber, for broadcasting viewing, and a memory for storing descrambling information for use in descrambling the scrambled broadcasting data.

In FIG. 1, the smart card interface 12 communicates with the smart card 14 using a key, for searching for the descrambling information stored in the smart card 14. When the smart card interface 12 sends the key to the smart card 14, the smart card 14 searches for descrambling information corresponding to the key and sends a response signal indicating broadcasting reception is available to the smart card interface 12.

FIG. 2 illustrates an interface structure for performing encryption using a Non-Volatile (N/V) memory in a typical conditional access system for receiving digital broadcasting.

Referring to FIG. 2, a unique value of a terminal used for communications between a smart card interface 22 of a CAS 20 and a smart card 24 is stored in an N/V memory 28. The smart card interface 22 reads the unique value from the N/V memory 28, encrypts a key with the unique value, and sends the encrypted key and the unique value to the smart card 24. The smart card 24 then decrypts the encrypted key with the unique value.

As illustrated in FIG. 2, since the smart card interface 22 encrypts a key with a terminal-specific value, even if a hacker attacks the communication algorithm between the smart card interface 22 and the smart card 24 and the key is disclosed, hacking on terminals with different keys is impossible.

The above interfacing technology is, however, vulnerable to hacking if the communication algorithm between the smart card interface 22 and the smart card 24 and the unique value used for key encryption are known, and no protection mechanism has been devised for the attacked terminal. Therefore, the developer and the user have a burden of being extremely careful against disclosure of the unique value as well as the communication algorithm.

Moreover, a unique value must be written in the N/V memory of each terminal in the course of fabrication. To do so, a production procedure and line needs to be changed for each terminal, increasing product cost and development delay.

### BRIEF DESCRIPTION OF THE DRAWINGS

The above and other objects, features and advantages of the present invention will become more apparent from the following detailed description when taken in conjunction with the accompanying drawings, in which:

FIG. 1 illustrates interfacing between a smart card and a smart card interface in a typical digital broadcast receiving terminal;

FIG. 2 illustrates an interface structure for performing encryption using a non-volatile memory in a typical conditional access system for receiving digital broadcasting;

FIG. 3 illustrates an interface structure for performing encryption using a random value in a digital broadcast receiving terminal according to a preferred embodiment of the present invention;

FIG. 4 is a flowchart illustrating an operation of a smart card interface in a terminal with a conditional access system according to a preferred embodiment of the present invention;

FIG. 5A is a flowchart illustrating an operation for acquiring location information about a path having a maximum energy according to a preferred embodiment of the present invention;

FIG. 5B is a flowchart illustrating an encryption operation using the location information about the path having the maximum energy according to a preferred embodiment of the present invention;

FIG. 6 is a block diagram of the terminal according to a preferred embodiment of the present invention; and

FIG. 7 is a detailed block diagram of a MODEM and a controller according to a preferred embodiment of the present invention.

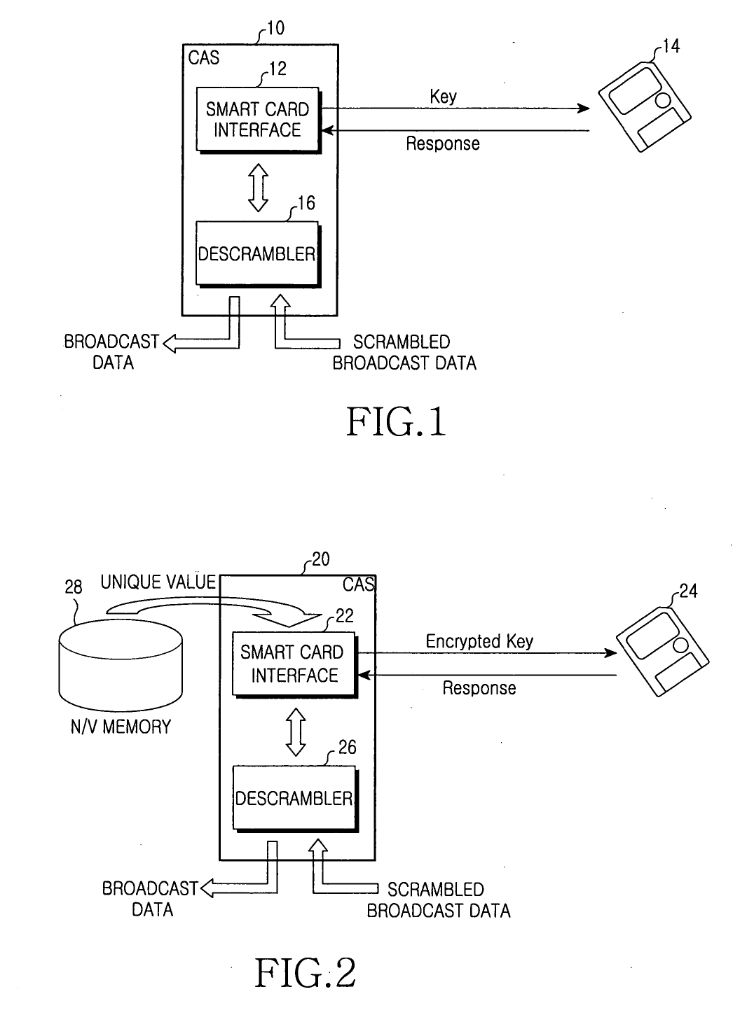

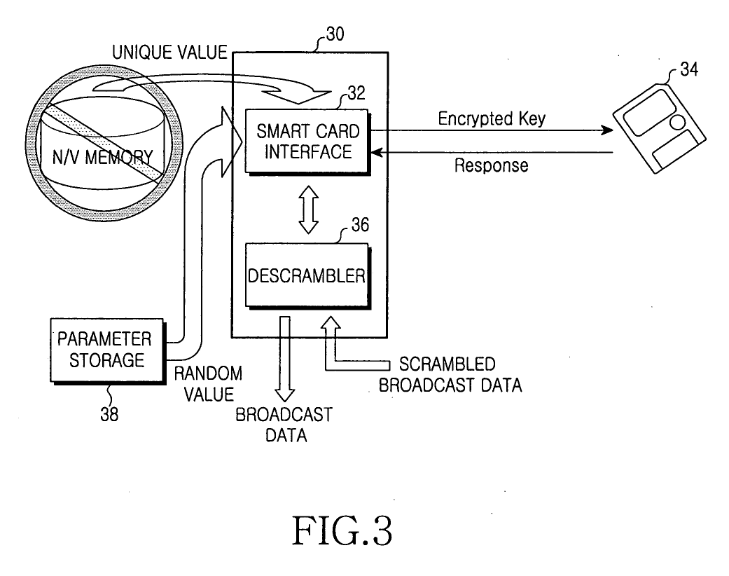

### SUMMARY OF THE INVENTION

Accordingly, the present invention provides a method and apparatus for enabling only authorized subscribers to receive broadcast programs by use of a random number for key encryption in a CAS for digital broadcasting.

The present invention provides a method and apparatus for using position information from a searcher as a random value for key encryption in a CAS for digital broadcasting.

In an encryption method in a Conditional Access System (CAS) which interworks with a smart card, for receiving digital broadcasting, a random value is acquired and a key used for communications with the smart card is encrypted with the random value. The encrypted key and the random value are sent to the smart card and a response signal for the key is received from the smart card.

In an encryption apparatus in a terminal having a Conditional Access System (CAS) which interworks with a smart card, for receiving digital broadcasting, a parameter storage stores a random value. A smart card interface reads the random value, encrypting a key used for communications with the smart card with the random value, sends the encrypted key and the random value to the smart card, and receives a response signal for the key from the smart card.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Embodiments of the present invention will be described in the context of a CAS which enables only DMB subscribers or authorized users to view broadcast programs. Yet, it is clearly understood to those skilled in the art that the encryption technology for the CAS according to the present invention is applicable to any other system having a similar technological background and configuration with a slight modification within the scope of the present invention.

A digital broadcast transmitter scrambles broadcast information messages and broadcast data streams prior to transmission in order to provide a broadcast service to authorized subscribers only. A terminal uses a CAS to descramble the scrambled messages and data streams. The CAS blocks unauthorized user from receiving digital broadcasting in conjunction with a smart card for storing descrambling information.

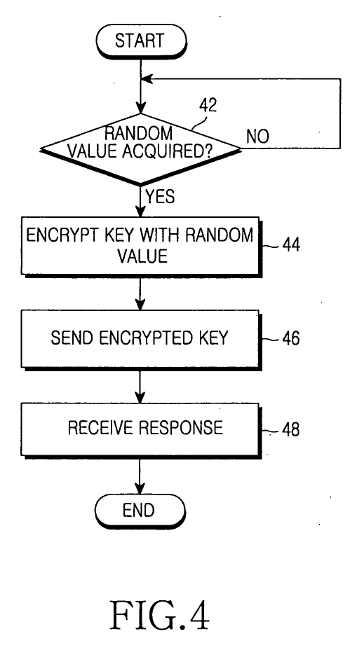

FIG. 3 illustrates an interface structure for performing encryption using a random value in a digital broadcast receiving terminal according to a preferred embodiment of the present invention.

Referring to FIG. 3, a CAS 30 built in the terminal includes a smart card interface 32 and a descrambler 36. It is responsible for authenticating and filtering messages and broadcast data streams received from a digital broadcast transmitter in conjunction with a parameter storage 38 for storing software parameters of the terminal and a smart card 34 for storing descrambling information. To be more specific, the smart card interface 32 performs mutual authentication between the smart card 34 and the terminal. The descrambler 36, which has a filter, descrambles the scrambled broadcast data received from the digital broadcast transmitter and outputs the original broadcast data. To provide descrambling information required for viewing digital broadcasting, the smart card 34 has an built-in chip on which a microprocessor and a memory are integrated. While the parameter storage 38 and the smart card 34 are separately configured in the CAS 30, they may be incorporated.

The smart card interface 32 communicates with the smart card 34 using a key by which to search for descrambling information in the smart card 34. The key has been received together with the scrambled broadcast data from the digital broadcast transmitter. Or the key can be acquired through user or developer-input or an external memory before receiving the digital broadcasting. The smart card interface 32 encrypts the key with a random value read from the parameter storage 38 and sends the encrypted key to the smart card 34. The smart card 34 decodes the encrypted key and, if the key is valid, sends descrambling information corresponding to the key by a response signal indicating communications is available to the smart card interface 32. The key can be said to be valid when the descrambling information corresponding to the key exists in the smart card 23.

The parameter storage 38 stores software parameters generated during the operations of the terminal and provides one of the parameters as the random value to the smart card interface 32. The descrambler 36 receives the descrambling information from the smart card interface 32 and descrambles the scrambled broadcast data received form the digital broadcast transmitter using the descrambling information, thereby recovering the original broadcast data.

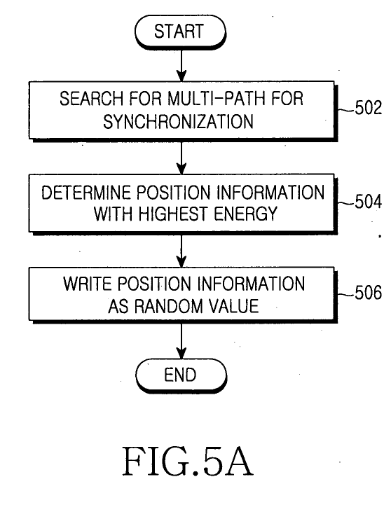

FIG. 4 is a flowchart illustrating the operation of the smart card interface 32 in the terminal with the CAS according to a preferred embodiment of the present invention.

Referring to FIG. 4, the smart card interface 32 attempts to read a random value from the parameter storage 38 in step 42. That is, the smart card interface 32 determines whether the random value exists at a predetermined address in the parameter storage 38. The predetermined address is an address where a random value is stored for encryption between the smart card interface 32 and the smart card 34.

In the absence of the random value in step 42, the smart card interface 32 continuously monitors the existence of the random value in the parameter storage 38. In the presence of the random value, the smart card interface 32 encrypts a key with the random value in step 44. The key is received form the digital broadcast transmitter to acquire descrambling information required to descramble scrambled broadcast data from the smart card 34.

In step 46, the smart card interface 32 sends the encrypted key and the random value to the smart card 34. The smart card 34 then decrypts the encrypted key with the random value and determines whether broadcast data reception is available by searching for descrambling information corresponding to the key. The smart card 34 sends a response signal indicating whether the broadcasting reception is available to the smart card interface 32. If the descrambling information corresponding to the key is detected, the smart card 34 provides the descrambling information to the smart card interface by the response signal.

The smart card interface 32 determines from the response signal whether the broadcasting reception is available in step 48. If the broadcasting reception is available, the smart card interface 32 sends the descrambling information to the descrambler 36. The descrambler 36 descrambles scrambled broadcast data received from the digital broadcast transmitter using the descrambling information, thereby recovering the original broadcast data.

A description will now be provided of an embodiment of the present invention in which position information determined by a multipath searcher of a terminal is used as a random value. In a radio environment, a plurality of paths with different propagation delays exist between a transmitter and a terminal. The terminal determines a path with the highest energy and its position information (i.e. propagation delay) within a search window using the multipath searcher and stores the highest energy and the position information as software parameters. The position information is random irrespective of time and place. Therefore, the position information is used as a random value with which to communicate with a smart card. The terminal can also acquire position information associated with the highest energy using the mutipath searcher in a single-path communication environment (e.g. wired (test) environment).

While the position information detected by the multipath searcher is used as a random value, it is obvious that any other parameter with randomness generated from the terminal can be used as the random value. The characteristics of the random value used in the embodiment of the present invention will be described below.

(1) Even if a plurality of terminals operate simultaneously at the same position, they cannot generate the same random value. In other words, they create different random values at the same time at the same position.

(2) A terminal generates a different random value each time its multipath searcher operates. That is, the terminal generates different random values at different time points.

When the user selects a menu item associated with digital broadcasting reception or presses a corresponding hot key, the terminal determines the position information of a highest energy path by operating the multipath searcher and simultaneously initializes the smart card through the smart card interface of the CAS. The embodiment of the present invention using the position information as a random value will be described in detail.

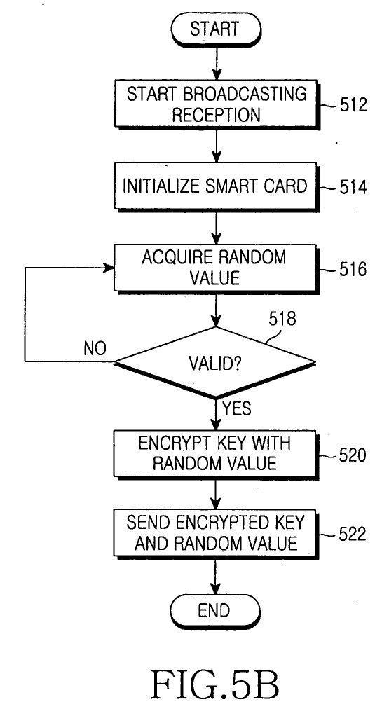

FIG. 5A is a flowchart illustrating an operation for acquiring the position information of a highest energy path in the terminal according to a preferred embodiment of the present invention.

Referring to FIG. 5A, upon user request for digital broadcasting reception, the terminal performs a path search to acquire synchronization to the transmitter in step 502. In step 504, the terminal selects paths with energies equal to or at a threshold using a signal received from the transmitter among multiple paths form the transmitter to the terminal and determines position information of the selected paths. The terminal writes the position information of a path with the highest energy among the selected paths as a random value at a predetermined address in the parameter storage, for encryption of communications with the smart card in step 506.

FIG. 5B is a flowchart illustrating an encryption operation based on the position information of a path with the highest energy according to a preferred embodiment of the present invention.

Referring to FIG. 5B, upon user request for digital broadcasting reception in step 512, the smart card interface initializes the smart card in step 514. The smart card initialization is the process of operating the smart card to the state where it can receive an encrypted key. In step 516, the smart card interface attempts to acquire a random value from a predetermined address in a volatile memory, for example, a Random Access Memory (RAM). The smart card interface determines whether the random value is valid in step 518. If the random value is position information within the search window of the multipath searcher, the smart card interface considers that the random value is valid. Otherwise, it returns to step 516 to continuously attempt to acquire a valid random value.

If the valid random value is acquired, the smart card interface encrypts a key with the random value in step 520 and sends the encrypted key and the random value to the smart card in step 522. Upon receipt of descrambling information in a response signal indicating available broadcasting reception from the smart card, the CAS can descramble scrambled broadcast data received from the digital broadcast transmitter using the descrambling information.

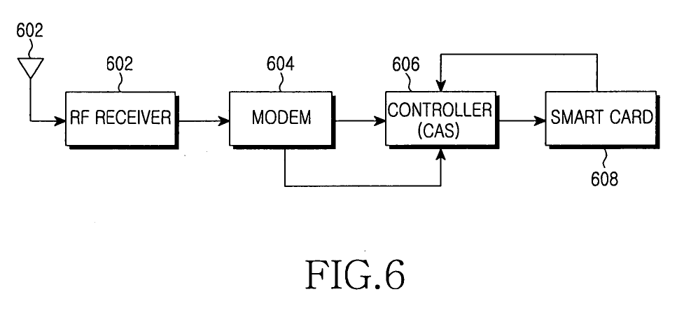

FIG. 6 is a block diagram of the terminal according to a preferred embodiment of the present invention. It is to be noted that only components associated with the present invention are shown.

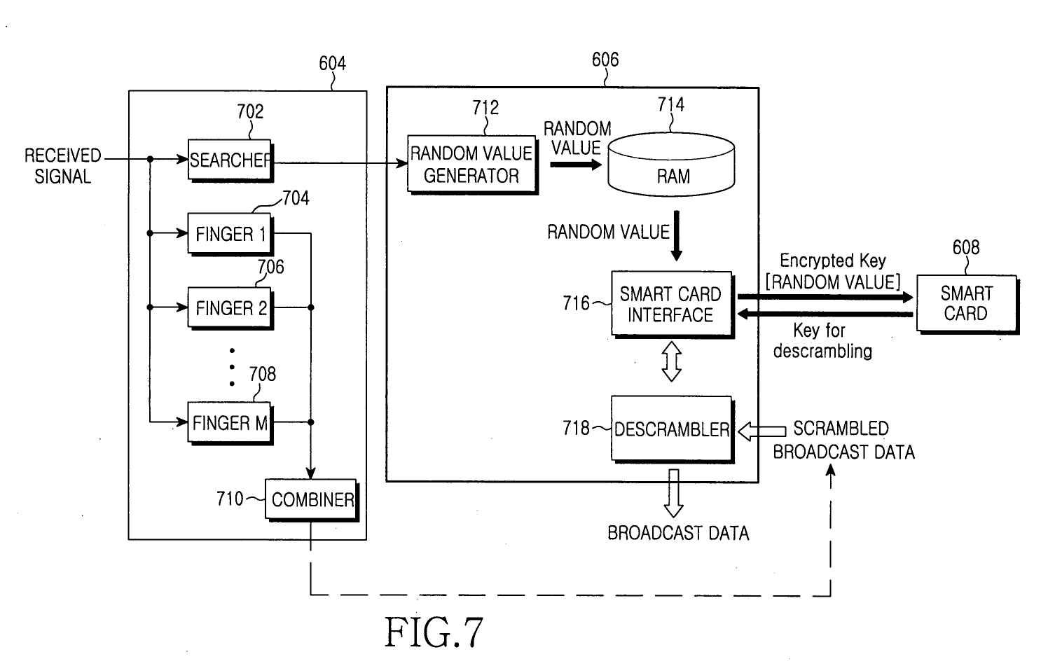

Referring to FIG. 6, the terminal includes an antenna 602, a Radio Frequency (RF) receiver 602, a MODEM 604, and a controller 606. The controller 606 has a CAS and is connected to a smart card 608. The MODEM 604 and the controller 606 are illustrated in more detail in FIG. 7. With reference to FIGS. 6 and 7, the terminal configuration will be described.

The antenna 602 receives RF signals from the digital broadcast transmitter in multiple paths. The RF receiver 602 downconverts the RF signals to a baseband broadcast signal. The MODEM 604 detects paths with energies equal to or higher than a threshold through a searcher 702 which detects the energy of the broadcast signal. The detected path signals are assigned to fingers 704, 706 and 708, demodulated in the fingers, combined in a combiner 710, and provided to a descrambler 718. The configurations of the searcher 702, the fingers 704, 706 and 708, and the combiner 710 which are illustrated in simplified forms regarding multipath signal reception are known to those of skill in the art, and the present invention is not limited to the illustrated configurations of the components.

The searcher 702 provides the position information, i.e. delay of a path with the highest energy among the detected paths to a random value generator 712. The random value generator 712 converts the position information in a predetermined format and writes it at a predetermined address in a RAM 714. For example, the random value generator 712 represents the position information in a predetermined number of bits. If a smart card interface 716 just uses the position information generated from the searcher 702, the random value generator 712 may not be provided.

The smart card interface 716 retrieves the random value from the predetermined address of the RAM 714, encrypts a key with the random value, and sends the encrypted key and the random value to the smart card 608. Upon receipt of descrambling information in a response signal indicating available broadcasting reception from the smart card 608, the smart card interface 716 provides the descrambling information to the descrambler 718. The descrambler 718 recovers the original broadcast data by descrambling scrambled broadcast data with the descrambling information.

While the present invention has been shown and described with reference to certain preferred embodiments thereof, it will be understood by those skilled in the art that various changes in form and details may be made therein without departing from the spirit and scope of the invention as defined by the appended claims.

For example, as described above, the present invention uses a random value instead of a fixed unique value in encrypting a key used for communications between a smart card interface and a smart card. Because the random value is terminal-specific, even if a hacker attacks a terminal and intercepts its random value, the hacker cannot attack another terminal using the random value. Moreover, the random value is different each time the terminal operates. Therefore, even if the hacker succeeds in intercepting the random value at one time, the hacker cannot attack the same terminal using the random value again.

Since the random value is generated as a software parameter, the fabrication process and line for storing a fixed unique value in an N/V memory need not be changed. Accordingly, additional development cost and time are saved and an overall throughput decrease is prevented.

1. An encryption method in a Conditional Access System (CAS) which interworks with a smart card, for receiving digital broadcasting, comprising the steps of:
acquiring a random value;
encrypting a key used for communications with the smart card with the random value;
sending the encrypted key and the random value to the smart card; and
receiving a response signal for the key from the smart card.

2. The encryption method of claim 1, further comprising acquiring descrambling information corresponding to the key in the response signal and descrambling scrambled broadcast data received from a digital broadcast transmitter with the descrambling information.

3. The encryption method of claim 2, wherein the key is received together with the scrambled broadcast data from the digital broadcast transmitter.

4. The encryption method of claim 1, wherein the random value represents position information of a highest energy path, determined by a signal searcher in a terminal.

5. The encryption method of claim 4, wherein the random value acquiring step comprises reading the random value from a predetermined address of a volatile memory.

6. The encryption method of claim 4, wherein the random value acquiring step comprises:
determining the position information of the highest energy path by operating the signal searcher of the terminal, upon request for digital broadcasting reception;
writing the position information as the random value at a predetermined address of a volatile memory; and
reading the random value from the predetermined address.

7. The encryption method of claim 6, wherein the random value acquiring step further comprises:
determining whether the read random value falls within a search window of the signal searcher; and
determining the position information as the random value, if the random value falls within the search window.

8. The encryption method of claim 6, wherein the random value acquiring step further comprises converting the position information to the random value in a predetermined format before writing the position information in the volatile memory.

9. An encryption apparatus in a terminal having a Conditional Access System (CAS) which interworks with a smart card, for receiving digital broadcasting, comprising:
a parameter storage for storing a random value; and
a smart card interface for reading the random value, encrypting a key used for communications with the smart card with the random value, sending the encrypted key and the random value to the smart card, and receiving a response signal for the key from the smart card.

10. The encryption apparatus of claim 9, wherein the smart card interface acquires descrambling information corresponding to the key in the response signal and provides the descrambling information to a descrambler so that the descrambler descrambles scrambled broadcast data received from a digital broadcast transmitter with the descrambling information.

11. The encryption apparatus of claim 10, wherein the key is received together with the scrambled broadcast data from the digital broadcast transmitter.

12. The encryption apparatus of claim 9, wherein the random value represents position information of a highest energy path, determined by a signal searcher in the terminal.

13. The encryption apparatus of claim 12, wherein the smart card interface reads the random value from a predetermined address of the parameter storage being a volatile memory.

14. The encryption apparatus of claim 12, wherein the signal searcher determines the position information of the highest energy path, upon request for digital broadcasting reception and writes the position information as the random value at a predetermined address of a volatile memory.

15. The encryption apparatus of claim 14, wherein the smart card interface determines whether the read random value read from the predetermined address falls within a search window of the signal searcher and, if the random value falls within the search window, determines the position information as the random value.

16. The encryption apparatus of claim 14, further comprising a random value generator for converting the position information to the random value in a predetermined format before writing the position information in the volatile memory.
